(19) United States
(12) Patent Application Publication
(10) Pub. No.: US 2012/0122429 A1
(43) Pub. Date: May 17, 2012

(54) METHOD FOR DIGITAL WATERMARK USE BY A MOBILE STATION

(75) Inventors: Andrew A. Wood, San Diego, CA (US); Manuel E. Jaime, (US); Chong U. Lee, San Diego, CA (US); Kamran Moallemi, San Diego, CA (US); Edward G. Atrero, San Marcos, CA (US); Ming-Chang Tsai, San Diego, CA (US)

(73) Assignee: QUALCOMM Incorporated, San Diego, CA (US)

(21) Appl. No.: 12/947,465

(22) Filed: Nov. 16, 2010

(51) Int. Cl. H04W 4/00

(52) U.S. Cl. 455/414.1

(57) ABSTRACT

Disclosed is a method for digital watermark use by a mobile station. In the method, a mobile station receives a plurality of digital watermarks. The mobile station detects at least two digital watermarks in the received plurality of watermarks. Based on the at least two detected digital watermarks, a user-specific rule is applied to select a predefined action. The mobile station performs the selected predefined action.

### BACKGROUND

1. Field

The present invention relates generally to digital watermark use by a mobile station.

2. Background

The field of communications has many applications including, e.g., paging, wireless local loops, Internet telephony, and satellite communication systems. An exemplary application is a cellular telephone system for mobile subscribers. (As used herein, the term “cellular” system encompasses both cellular and personal communications services (PCS) system frequencies.) Modem communication systems, such as a wireless communication system, designed to allow multiple users to access a common communications medium have been developed for such cellular systems. These modem communication systems may be based on multiple access techniques such as code division multiple access (CDMA), time division multiple access (TDMA), frequency division multiple access (FDMA), space division multiple access (SDMA), polarization division multiple access (PDMA), or other modulation techniques known in the art. These modulation techniques demodulate signals received from multiple users of a communication system, thereby enabling an increase in the capacity of the communication system. In connection therewith, various wireless communication systems have been established including, e.g., Advanced Mobile Phone Service (AMPS), Global System for Mobile communication (GSM), and other wireless systems.

In FDMA systems, the total frequency spectrum is divided into a number of smaller sub-bands and each user is given its own sub-band to access the communication medium. Alternatively, in TDMA systems, the total frequency spectrum is divided into a number of smaller sub-bands, each sub-band is shared among a number of users, and each user is allowed to transmit in predetermined time slots using that sub-band. A CDMA system provides potential advantages over other types of systems, including increased system capacity. In CDMA systems, each user is given the entire frequency spectrum for all of the time, but distinguishes its transmission through the use of a unique code.

A mobile station may be exposed to content from a large number of sources, and the content may be encoded with at least one digital watermark. Effectively using the digital watermarks from a large number of sources may present a daunting challenge.

There is therefore a need for a technique for effectively and efficiently using digital watermarks in content available to a mobile station from a plurality of sources.

### SUMMARY

An aspect of the present invention may reside in a method for digital watermark use by a mobile station. In the method, a mobile station receives a plurality of digital watermarks. The mobile station detects at least two digital watermarks in the received plurality of watermarks. Based on the at least two detected digital watermarks, a user-specific rule is applied to select a predefined action. The mobile station performs the selected predefined action.

In more detailed aspects of the invention, the user-specific rule may be based on a personal preference or a context of a user of the mobile station. Also, the predefined action may be selected based on a personal preference or a context a user of the mobile station. The selected predefined action may include sharing information with a social network. The social network may include at least one user of another station, such as a friend or a parent.

In other more detailed aspects of the invention, at least one of the plurality of digital watermarks may be received through an audio signal. Additionally, at least one of the plurality of digital watermarks may be received through a visual image. The at least two detected watermarks may be concurrent. The detected digital watermarks may be decoded by the mobile station, or by a remote station of a network. Applying a user-specific rule to select a predefined action based on the at least two detected digital watermarks may further include filtering watermarks from the detected watermarks.

Another aspect of the invention may reside in a mobile station comprising: means for receiving a plurality of digital watermarks; means for detecting at least two digital watermarks in the received plurality of watermarks; means for applying a user-specific rule to select a predefined action based on the at least two detected digital watermarks; and means for performing the selected predefined action.

Another aspect of the invention may reside in a mobile station comprising a processor configured to: receive a plurality of digital watermarks; detect at least two digital watermarks in the received plurality of watermarks; apply a user-specific rule to select a predefined action based on the at least two detected digital watermarks; and perform the selected predefined action.

Yet another aspect of the invention may reside in a computer program product comprising computer-readable medium, comprising: code for causing a computer to receive a plurality of digital watermarks; code for causing a computer to detect at least two digital watermarks in the received plurality of watermarks; code for causing a computer to apply a user-specific rule to select a predefined action based on the at least two detected digital watermarks; and code for causing a computer to perform the selected predefined action.

### BRIEF DESCRIPTION OF THE DRAWINGS

FIG. 1 is a block diagram of an example of a wireless communication system.

FIG. 2 is a block diagram of an example of a mobile station.

FIG. 3 is a flow diagram of a method for digital watermark use by a mobile station, according to the present invention.

FIG. 4 is a flow diagram of a method showing remote rule application, and remote or local watermark decoding, according to the present invention.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

A remote station, also known as a mobile station (MS), an access terminal (AT), user equipment (UE) or subscriber unit, may be mobile or stationary, and may communicate with one or more base stations, also known as base transceiver stations (BTSs) or node Bs. A remote station transmits and receives data packets through one or more base stations to a base station controller, also known as radio network controllers (RNCs). Base stations and base station controllers are parts of a network called an access network. The access network may contain alternatively other type of elements such as Access Points (AP) and Access Routers (AR). An access network transports data packets to and from multiple remote stations. The access network may be further connected to additional networks outside the access network, such as a corporate intranet or the Internet, and may transport data packets between each remote station and such outside networks. A remote station that has established an active traffic channel connection via one or more base stations is called an active remote station, and is said to be in a traffic state. A remote station that is in the process of establishing an active traffic channel connection via one or more base stations is said to be in a connection setup state. A remote station may be any data device that communicates through a wireless channel. A remote station may further be any of a number of types of devices including but not limited to PC card, compact flash, external or internal modern, or wireless phone. The communication link through which the remote station sends signals via the base station is called an uplink, also known as a reverse link. The communication link through which a signals are sent to a remote station via base station is called a downlink, also known as a forward link.

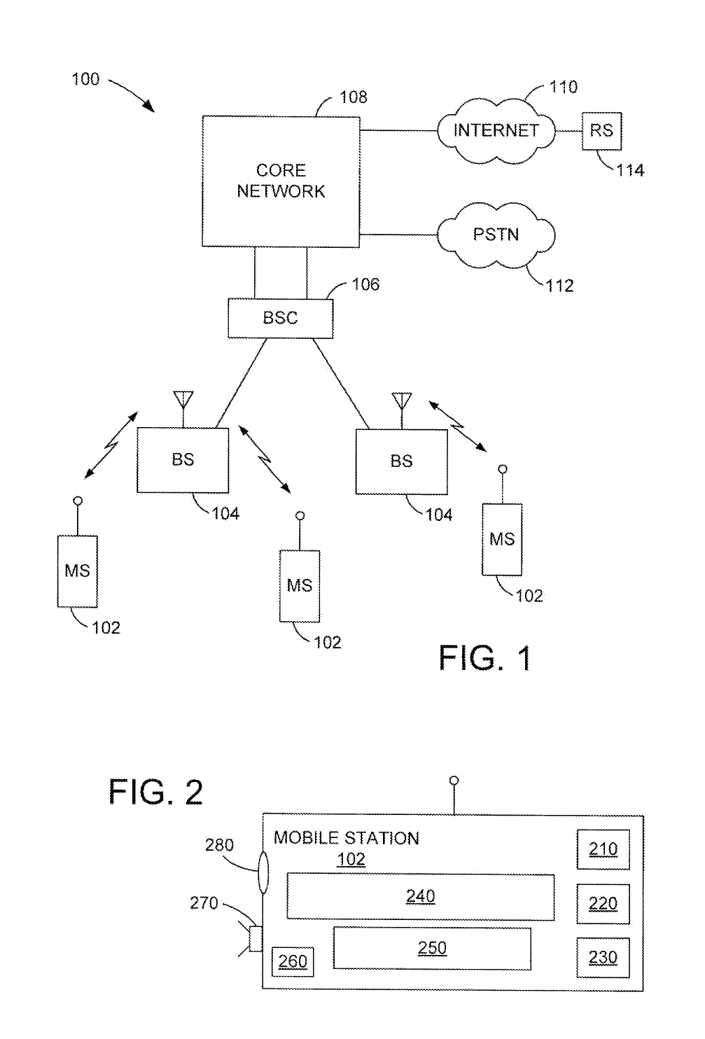

With reference to FIG. 1, a wireless communication system 100 includes one or more wireless mobile stations (MS) 102, one or more base stations (BS) 104, one or more base station controllers (BSC) 106, and a core network 108. Core network may be connected to Internet 110 and a Public Switched Telephone Network (PSTN) 112 via suitable backhauls. A typical wireless mobile station may include a handheld phone, mobile Internet device, or a laptop computer. Wireless communication system 100 may employ any one of a number of multiple access techniques such as code division multiple access (CDMA), time division multiple access (TDMA), frequency division multiple access (FDMA), space division multiple access (SDMA), polarization division multiple access (PDMA), or other modulation techniques.

With reference to FIG. 2, the mobile station 102 may include a processor 210, memory (and/or disk drives) 220, secure module 230, display 240, keypad or keyboard 250, microphone 260, speaker(s) 270, camera 280, and the like. Further, the remote station may also include USB, Ethernet and similar interfaces.

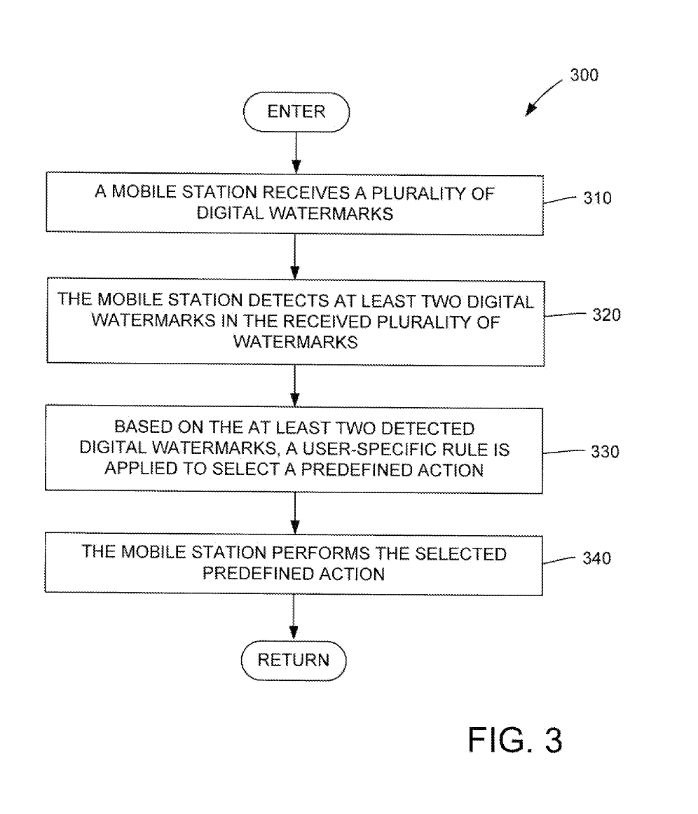

With reference also to FIG. 3, an aspect of the present invention may reside in a method 300 for digital watermark use by a mobile station 102. In the method, a mobile station receives a plurality of digital watermarks (step 310). The mobile station detects at least two digital watermarks in the received plurality of watermarks (step 320). Based on the at least two detected digital watermarks, a user-specific rule is applied to select a predefined action (step 330). The mobile station performs the selected predefined action (step 340).

A digital watermark is information embedded into a digital signal in a way that may be difficult to remove. A digital signal may carry several different digital watermarks at the same time. If the watermarked signal is copied, the digital watermark is also carried in the copy. Often a digital watermark is virtually imperceptible to a user, while being readily detectable using digital processing techniques.

The user-specific rule may be based on a personal preference and/or a context of a user of the mobile station 102. In addition, the predefined action may be also selected based on a personal preference and/or a context a user of the mobile station. The user context may include a user attribute, profile, location, state (speed, direction, orientation), focus of attention, object dwell time, event, time, day, season, etc.

At least one of the plurality of digital watermarks may be received through an audio signal. Additionally, at least one of the plurality of digital watermarks may be received through a visual image. The detected watermarks may be concurrent.

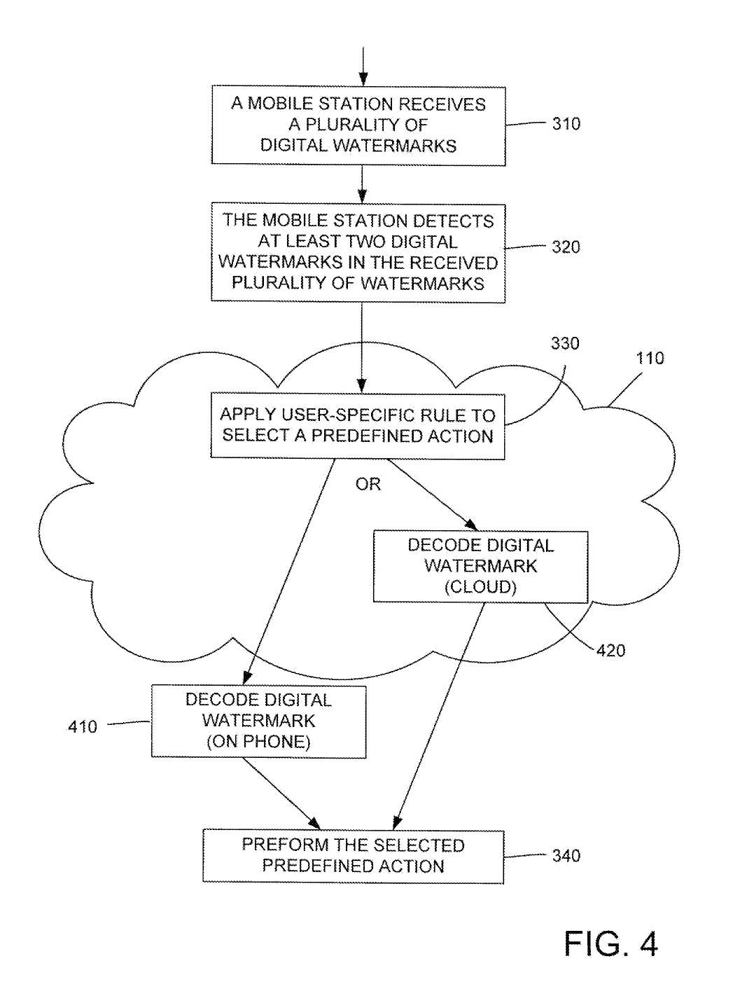

With reference to FIG. 4, a remote station 114 (FIG. 1) which is accessible through the internet 110 may apply the user specific rule to select the predetermined action (step 330). This may facilitate lightweight mobile stations 102. The detected digital watermarks may be decoded by the mobile station 102 (step 410), or by a remote station 114 of a network (step 420).

Applying a user-specific rule to select a predefined action based on the at least two detected digital watermarks may further include filtering watermarks from the detected watermarks. The rules and filters may be employed to converge on digital watermarks that may be relevant to the user given his/her state and preferences. Also, historical user interaction with digital watermarks may be employed. The user's personal preferences may be manually set by the user. Alternatively, the user's preferences may be set by a machine learning system that is trained to converge on a user's preferences over time. Using the rules and filters, a user may be presented with a predefined action based only on digital watermarks that are deemed with a high relevance level. This is advantageous because the user's cognitive load (as well as device capabilities) may only allow for processing of a small subset of a large number of digital watermarks present at a given time.

The mobile station 102 may comprise cell phones, PDAs, automobiles, multi-media devices, laptop computers, navigation systems, or the like. Also, different devices can collaborate in real-time to augment capabilities. Embodiments can also provide for buffering, stack ranking, prioritizing, and queuing execution of watermarks as well as aging out processed or soon to be processed watermarks if their relevancy has faded over time (e.g., value of information is a function of timeliness, proximity, and user state).

The selected predefined action may include sharing information with a social network. The social network may include at least one user of another station, such as a friend or a parent.

Social networking functionality can be built into or associated with the digital watermarks. When digital watermarks are decoded by an individual, that event may be of interest to a friend or family member of the user. The decoding event could trigger a service that allows for sharing of the content with a friend or family member. Digital watermarks may be used to allow for a predetermined number of users to concurrently view content if executed by an individual within a social network. Member of the network may be given permission as well as receive alerts to view or listen to content at the same time as a friend or family member.

One use scenario would be to concurrently trigger decoding of the digital watermarks and play content for a user as well as have it transmitted to certain people on a buddy list. There may be shared keys by people on a buddy list that allows for them to share and distribute content within an authorized group of people.

Parental review mechanisms can be built in where parents are notified when digital watermarks are decoded by a kid's device. Purchase or use information can be logged or transmitted to another.

Another aspect of the invention may reside in a mobile station 102 comprising: means 210 for receiving a plurality of digital watermarks; means for detecting at least two digital watermarks in the received plurality of watermarks; means for applying a user-specific rule to select a predefined action based on the at least two detected digital watermarks; and means for performing the selected predefined action.

Another aspect of the invention may reside in a mobile station 102 comprising a processor 210 configured to: receive a plurality of digital watermarks; detect at least two digital watermarks in the received plurality of watermarks; apply a user-specific rule to select a predefined action based on the at least two detected digital watermarks; and perform the selected predefined action.

Yet another aspect of the invention may reside in a computer program product comprising non-transitory computer-readable medium 220, comprising: code for causing a computer to receive a plurality of digital watermarks; code for causing a computer to detect at least two digital watermarks in the received plurality of watermarks; code for causing a computer to apply a user-specific rule to select a predefined action based on the at least two detected digital watermarks; and code for causing a computer to perform the selected predefined action.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on as one or more instructions or code on a computer-readable medium. Computer-readable media includes computer storage media that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer-readable medium may be non-transitory such that it does not include a transitory, propagating signal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to he limited to the embodiments shown herein but is to be accorded the widest scope consistent with the principles and novel features disclosed herein.

What is claimed is:

1. A method, comprising:
a mobile station receiving a plurality of digital watermarks;
the mobile station detecting at least two digital watermarks in the received plurality of watermarks;
based on the at least two detected digital watermarks, applying a user-specific rule to select a predefined action; and
the mobile station performing the selected predefined action.

2. A method as defined in claim 1, wherein the user-specific rule is based on a personal preference of a user of the mobile station.

3. A method as defined in claim 1, wherein the user-specific rule is based on a context of a user of the mobile station.

4. A method as defined in claim 1, wherein the predefined action is also selected based on a personal preference of a user of the mobile station.

5. A method as defined in claim 1, wherein the predefined action is also selected based on a user context.

6. A method as defined in claim 1, further comprising the mobile station decoding the detected digital watermarks.

7. A method as defined in claim 1, further comprising remotely decoding the detected digital watermarks by a remote station of a network.

8. A method as defined in claim 1, wherein at least one of the plurality of digital watermarks is received through an audio signal.

9. A method as defined in claim 1, wherein at least one of the plurality of digital watermarks is received through a visual image.

10. A method as defined in claim 9, wherein at least one of the plurality of digital watermarks is received through an audio signal.

11. A method as defined in claim 1, wherein the selected predefined action comprises sharing information with a social network.

12. A method as defined in claim 11, wherein the social network comprises at least one user of another station.

13. A method as defined in claim 12, wherein the at least one user of another station comprises a friend.

14. A method as defined in claim 12, wherein the at least one user of another station comprises a parent.

15. A method as defined in claim 1, wherein the at least two detected watermarks are concurrent.

16. A method as defined in claim 1, wherein applying a user-specific rule to select a predefined action based on the at least two detected digital watermarks further comprises filtering watermarks from the detected watermarks.

17. A mobile station, comprising:
means for receiving a plurality of digital watermarks;
means for detecting at least two digital watermarks in the received plurality of watermarks;
means for applying a user-specific rule to select a predefined action based on the at least two detected digital watermarks; and
means for performing the selected predefined action.

18. A mobile station as defined in claim 17, wherein the user-specific rule is based on a personal preference of a user of the mobile station.

19. A mobile station as defined in claim 17, wherein the user-specific rule is based on a context of a user of the mobile station.

20. A mobile station as defined in claim 17, wherein the predefined action is also selected based on a personal preference of a user of the mobile station.

21. A mobile station as defined in claim 17, wherein the predefined action is also selected based on a user context.

22. A mobile station as defined in claim 17, further comprising means for decoding the detected digital watermarks.

23. A mobile station as defined in claim 17, wherein at least one of the plurality of digital watermarks is received through an audio signal.

24. A mobile station as defined in claim 17, wherein at least one of the plurality of digital watermarks is received through a visual image.

25. A mobile station as defined in claim 24, wherein at least one of the plurality of digital watermarks is received through an audio signal.

26. A mobile station as defined in claim 17, wherein the selected predefined action comprises sharing information with a social network.

27. A mobile station as defined in claim 26, wherein the social network comprises at least one user of another station.

28. A mobile station as defined in claim 27, wherein the at least one user of another station comprises a friend.

29. A mobile station as defined in claim 27, wherein the at least one user of another station comprises a parent.

30. A mobile station as defined in claim 17, wherein the at least two detected watermarks are concurrent.

31. A mobile station as defined in claim 17, wherein the means for applying a user-specific rule to select a predefined action based on the at least two detected digital watermarks further comprises means for filtering watermarks from the detected watermarks.

32. A mobile station, comprising:
a processor configured to:
receive a plurality of digital watermarks;
detect at least two digital watermarks in the received plurality of watermarks;
apply a user-specific rule to select a predefined action based on the at least two detected digital watermarks; and
perform the selected predefined action.

33. A mobile station as defined in claim 32, wherein the user-specific rule is based on a personal preference of a user of the mobile station.

34. A mobile station as defined in claim 32, wherein the user-specific rule is based on a context of a user of the mobile station.

35. A mobile station as defined in claim 32, wherein the predefined action is also selected based on a personal preference of a user of the mobile station.

36. A mobile station as defined in claim 32, wherein the predefined action is also selected based on a user context.

37. A mobile station as defined in claim 32, wherein the processor is further configured to decode the detected digital watermarks.

38. A mobile station as defined in claim 32, wherein at least one of the plurality of digital watermarks is received through an audio signal.

39. A mobile station as defined in claim 32, wherein at least one of the plurality of digital watermarks is received through a visual image.

40. A mobile station as defined in claim 39, wherein at least one of the plurality of digital watermarks is received through an audio signal.

41. A mobile station as defined in claim 32, wherein the selected predefined action comprises sharing information with a social network.

42. A mobile station as defined in claim 41, wherein the social network comprises at least one user of another station.

43. A mobile station as defined in claim 42, wherein the at least one user of another station comprises a friend.

44. A mobile station as defined in claim 42, wherein the at least one user of another station comprises a parent.

45. A mobile station as defined in claim 32, wherein the at least two detected watermarks are concurrent.

46. A mobile station as defined in claim 32, wherein to apply a user-specific rule to select a predefined action based on the at least two detected digital watermarks further comprises to filter watermarks from the detected watermarks.

47. A computer program product, comprising:
computer-readable medium, comprising:
code for causing a computer to receive a plurality of digital watermarks;
code for causing a computer to detect at least two digital watermarks in the received plurality of watermarks;
code for causing a computer to apply a user-specific rule to select a predefined action, based on the at least two detected digital watermarks; and
code for causing a computer to perform the selected predefined action.

48. A computer program product as defined in claim 47, wherein the user-specific rule is based on a personal preference of a user of a mobile station.

49. A computer program product as defined in claim 47, wherein the user-specific rule is based on a context of a user of a mobile station.

50. A computer program product as defined in claim 47, wherein the predefined action is also selected based on a personal preference of a user of the mobile station.

51. A computer program product as defined in claim 47, wherein the predefined action is also selected based on a user context.

52. A computer program product as defined in claim 47, further comprising code for causing a computer to decode the detected digital watermarks.

53. A computer program product as defined in claim 47, wherein at least one of the plurality of digital watermarks is received through an audio signal.

54. A computer program product as defined in claim 47, wherein at least one of the plurality of digital watermarks is received through a visual image.

55. A computer program product as defined in claim 54, wherein at least one of the plurality of digital watermarks is received through an audio signal.

56. A computer program product as defined in claim 47, wherein the selected predefined action comprises sharing information with a social network.

57. A computer program product as defined in claim 56, wherein the social network comprises at least one user of another station.

58. A computer program product as defined in claim 57, wherein the at least one user of another station comprises a friend.

59. A computer program product as defined in claim 57, wherein the at least one user of another station comprises a parent.

60. A computer program product as defined in claim 47, wherein the at least two detected watermarks are concurrent.

61. A computer program product as defined in claim 47, wherein the code for causing a computer to apply a user-specific rule to select a predefined action based on the at least two detected digital watermarks further comprises code for causing a computer to filter watermarks from the detected watermarks.
